(19) United States
(12) Patent Application Publication
(10) Pub. No.: US 2025/0158724 A1
(43) Pub. Date: May 15, 2025

(54) TESTING WIRELESS DEVICE COHERENCE TRANSMISSION RELATING TO JOINT CHANNEL ESTIMATION

(71) Applicant: Telefonaktiebolaget LM Ericsson (publ), Stockholm (SE)

(72) Inventors: Chunhui ZHANG, Stockholm (SE); Johan AXNÄS, Solna (SE); Robert Mark HARRISON, Grapevine, TX (US); Anqi HE, Beijing (CN)

(21) Appl. No.: 18/836,140

(22) PCT Filed: Feb. 10, 2023
(86) PCT No.: PCT/SE2023/050110

§ 371 Date: Aug. 6, 2024

Related U.S. Application Data
(60) Provisional application No. 63/309,301, filed on Feb. 11, 2022.

(51) Int. Cl. H04B 17/309

(52) U.S. Cl. CPC H04B 17/309

(57) ABSTRACT

A testing device (17) is provided. The testing device (17) includes processing circuitry (66) configured to measure a plurality of channel responses associated with a plurality of subcarriers in a plurality of time slots, determine a plurality of phase offsets where each one of the plurality of phase offsets corresponds to a phase offset between the measured channel response in a first time slot and the measured channel response in a reference time slot over a respective one of plurality of subcarriers and where the first time slot is part of the plurality of time slots, determine a composite phase offset value based on the plurality of phase offsets, and determine a wireless device transmission coherence performance based on the composite phase offset value.

### TECHNICAL FIELD

The present disclosure relates to wireless communications, and in particular, to testing wireless device (WD) coherence transmission related to joint channel estimation.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

### PUSCH Repetition and TBoMS

Slot aggregation for the physical uplink shared channel (PUSCH) is supported in 3GPP Technical Release 15 (3GPP Rel-15) and was renamed to PUSCH Repetition Type A in 3GPP Rel-16. The name PUSCH repetition Type A is used even if there is only a single repetition, i.e., no slot aggregation. In 3GPP Rel. 15, a PUSCH transmission that would overlap with downlink (DL) symbols is not transmitted.
For downlink control information (DCI) granted multi-slot transmission (physical downlink shared channel (PDSCH)/PUSCH) vs. semi-static DL/uplink (UL) assignment:
   If semi-static DL/UL assignment configuration of a slot has no direction conflict with scheduled PDSCH/PUSCH assigned symbols, the PDSCH/PUSCH in that slot is received/transmitted; and
   If semi-static DL/UL assignment configuration of a slot has direction conflict with scheduled PDSCH/PUSCH assigned symbols, the PDSCH/PUSCH transmission in that slot is not received/transmitted, i.e., the effective number of repetitions reduces.

In 3GPP Rel. 15, the number of repetitions is semi-statically configured by radio resource control (RRC) parameter pusch-AggregationFactor. At most 8 repetitions are supported.
pusch-AggregationFactor ENUMERATED {n2, n4, n8}

A new repetition format, PUSCH repetition Type B, is supported in 3GPP Rel-16, which allows back-to-back repetition of PUSCH transmissions. A difference between repetition Type B and repetition Type A is that repetition Type A only allows a single repetition in each slot, with each repetition occupying the same symbols. Using this format with a PUSCH length shorter than 14 introduces gaps between repetitions, increasing the overall latency. Another change compared to 3GPP Rel-15 is how the number of repetitions is signaled. In 3GPP Rel. 15, the number of repetitions is semi-statically configured, while in 3GPP Rel. 16, the number of repetitions can be indicated dynamically in DCI. This applies both to dynamic grants and configured grants type 2.

In 3GPP NR Rel-15/16, one UL transport block (TB) is confined to the UL symbols in a slot. To support high data rate, multiple physical resource blocks (PRBs) in a slot can be used for the transmission of a large TB and the multiple PRBs share WD transmission power. Transport block (TB) processing over multiple slots (TBoMS) was proposed and specified as a candidate solution of coverage enhancement of PUSCH in 3GPP NR Rel-17. This multi-slot TB transmission extends the time domain resource for the transmission of a TB across slot borders to increase total power for transmission of a TB compared to TB transmission in a single slot. Multi-slot TB transmission also reduces cyclic redundancy check (CRC) overhead by reducing the number of CRCs in a given number of slots compared to the PUSCH transmissions at the same data rate with separate TBs.

### Phase-Related WD Capabilities

In 3GPP NR Rel-16, requirements of phase and power error difference between antenna ports are defined with the following text copied from 3GPP Technical Standard (TS) 38.101-1 v16.3.0:
“6.4D.4 Requirements for coherent UL MIMO
For coherent UL MIMO, Table 6.4D.4-1 lists the maximum allowable difference between the measured relative power and phase errors between different antenna ports in any slot within the specified time window from the last transmitted SRS on the same antenna ports, for the purpose of uplink transmission (codebook or non-codebook usage) and those measured at that last SRS. The requirements in Table 6.4D.4-1 apply when the UL transmission power at each antenna port is larger than 0 dBm for SRS transmission and for the duration of time window.”

TABLE 6.4D.4-1
Maximum allowable difference of relative phase and power errors in
a given slot compared to those measured at last SRS transmitted

| Difference of relative | Difference of relative | |
|---|---|---|
| phase error | power error | Time window |
| 40 degrees | 4 dB | 20 msec |

### Joint Channel Estimation for NR Coverage Enhancement

For the NR coverage enhancements work item (WI) for 3GPP Rel-17, it has been considered to investigate standardization of PUSCH cross-slot channel estimation, often referred to as joint channel estimation for PUSCH.

In an NR base station (gNB), the reception of PUSCH on a high level typically consists of two steps: (i) estimation of the physical channel based on measurements of reference symbols (e.g., demodulation reference signals (DMRS)) and (ii) equalize, demodulate, and decode the signal base on the estimated channel.

In existing releases of NR (3GPP Rel-15/16), the gNB performs the channel estimation (or at least the channel filtering part of it) on each slot individually, since different slots may have different random phase offsets, timing differences, and/or other differences that may make cross-slot channel filtering impossible.

### 3GPP Rel-17 Enhancements

In a NR coverage enhancements work item (WI) for 3GPP Rel-17, support for PUSCH cross-slot channel estimation, or joint channel estimation as it is called in 3GPP was considered. It is noted that these two terms will mostly be treated as synonyms in this disclosure. The idea is to impose some constraints on the WD regarding phase changes, etc., between slots in order to allow the gNB to estimate the channel jointly for multiple slots. Such joint processing over multiple slots can improve the channel estimation quality, and thereby improve overall link and system performance.

The NR coverage enhancements work item description (WID, 3GPP RP-202928) states:
Specification of PUSCH enhancements [RAN1, RAN4]:
   . . .
   Specify mechanism(s) to enable joint channel estimation [RAN1, RAN4];
      Mechanism(s) to enable joint channel estimation over multiple PUSCH transmissions, based on the conditions to keep power consistency and phase continuity to be investigated and specified if necessary by RAN4 [RAN1, RAN4]:
         Potential optimization of DMRS location/granularity in time domain is not precluded;
      Inter-slot frequency hopping with inter-slot bundling to enable joint channel estimation [RAN1].

### Pre Fast Fourier Transform (FFT) Minimization Process

Pre FFT minimization process is specified in Annex E.3.1 of 38.521-2 V16.8.0:

Before applying the pre-FFT minimization process, z(v) and i(v) are portioned into n pieces, comprising one slot each, where n is as defined in Annex E.2.2.

Each slot is processed separately. Sample timing, Carrier frequency and carrier leakage in z(v) are jointly varied in order to minimize the difference between z(v) and i(v). Best fit (minimum difference) is achieved when the RMS difference value between z(v) and i(v) is an absolute minimum.

The carrier frequency variation and the IQ variation are the measurement results: Carrier Frequency Error and Carrier leakage.

From the acquired samples 10 carrier frequencies can be derived by averaging frequency errors for every 4 or 8 slots for 60 and 120 kHz SCS.

From the acquired samples n carrier frequencies and n carrier leakages can be derived.
NOTE 1: The minimisation process, to derive carrier leakage and RF error can be supported by Post FFT operations. However, the minimisation process defined in the pre FFT domain comprises all acquired samples (i.e., it does not exclude the samples in between the FFT widths and it does not exclude the bandwidth outside the transmission bandwidth configuration.
NOTE 2: The algorithm would allow deriving Carrier Frequency error and Sample Frequency error of the transmit (TX) under test separately. However, there are no requirements for Sample Frequency error. Hence the algorithm models the RF and the sample frequency commonly (not independently). It returns one error and does not distinguish between both.

After this process the samples z(v) are called z° (v).

### SUMMARY

Some embodiments advantageously provide methods and network nodes for testing wireless device (WD) coherence transmission related to joint channel estimation.

A test method to measure the TX coherence in terms of the phase and amplitude variation in the frequency response of the WD radio frequency (RF) transmitter is provided. In some embodiments, equations are used to derive the magnitude of phase distortion variation by the WD transmitter in cross time slots. Some embodiments provide carrier frequency offset (CFO) compensation after fast Fourier transform (FFT) processing.

According to one aspect of the present disclosure, a testing device configured to communicate with a wireless device is provided. The testing device includes processing circuitry configured to: measure a plurality of channel responses associated with a plurality of subcarriers in a plurality of time slots, determine a plurality of phase offsets where each one of the plurality of phase offsets corresponds to a phase offset between the measured channel response in a first time slot and the measured channel response in a reference time slot over a respective one of plurality of subcarriers, the first time slot being part of the plurality of time slots, determine a composite phase offset value based on the plurality of phase offsets; and, determine a wireless device transmission coherence performance based on the composite phase offset value.

According to one or more embodiments of this aspect, the processing circuitry is further configured to select a maximum value of the plurality of phase offsets associated with the first time slot.

According to one or more embodiments of this aspect, the processing circuitry is further configured to determine an additional plurality of phase offsets where each one of the additional plurality of phase offsets corresponds to a phase offset between the measured channel response in a second time slot and the measured channel response in the reference time slot over a respective one of plurality of subcarriers and where the second time slot is part of the set of time slots, and where the composite phase offset value is based on the additional plurality of phase offsets.

According to one or more embodiments of this aspect, the determining of the composite phase offset value includes selecting a maximum absolute phase offset value over all DMRS subcarriers.

According to one or more embodiments of this aspect, the determining of the composite phase offset value includes calculating a root mean square of maximum phase offset values for each of the plurality of time slots.

According to one or more embodiments of this aspect, the determining of the composite phase offset value includes determining a percentile ranking of the phase offsets of the plurality of time slots where the composite phase offset value corresponds to a phase offset value associated with a predefined percentile ranking.

According to one or more embodiments of this aspect, the plurality of subcarriers are associated with a phase offset measurement.

According to one or more embodiments of this aspect, the measuring of the plurality of channel responses are based on uplink transmissions from the wireless device in the plurality of time slots.

According to one or more embodiments of this aspect, the uplink transmissions correspond to repetitions of physical channel transmissions among which the wireless device is configured to control relative phase associated with the physical channel transmissions.

According to one or more embodiments of this aspect, the processing circuitry is further configured to report at least one of the wireless device transmission coherence performance and the composite phase offset value.

According to one or more embodiments of this aspect, the plurality of channel responses associated with the plurality of subcarriers in the plurality of time slots does not include channel responses at a frequency band edge.

According to another aspect of the present disclosure, a wireless device is provided. The wireless device includes processing circuitry configured to cause uplink transmission on a plurality of subcarriers in a plurality of time slots for wireless device transmission coherence performance determination by the network node based on a plurality of channel responses associated with the uplink transmission where the wireless device transmission coherence performance determination is based on a composite phase offset value derived in part from the plurality of channel responses, and where the uplink transmission comprising a repetition of a physical channel in the plurality of time slots where the wireless device controls the relative phase among the uplink transmissions in the time slots.

According to another aspect of the present disclosure, a method implemented by a testing device that is configured to communicate with a wireless device is provided. A plurality of channel responses associated with a plurality of subcarriers in a plurality of time slots are measured. A plurality of phase offsets are determined where each one of the plurality of phase offsets correspond to a phase offset between the measured channel response in a first time slot and the measured channel response in a reference time slot over a respective one of plurality of subcarriers where the first time slot are part of the plurality of time slots. A composite phase offset value is determined based on the plurality of phase offsets. A wireless device transmission coherence performance is determined based on the composite phase offset value.

According to another aspect of the present disclosure, a maximum value of the plurality of phase offsets associated with the first time slot are selected.

According to another aspect of the present disclosure, an additional plurality of phase offsets are determined where each one of the additional plurality of phase offsets correspond to a phase offset between the measured channel response in a second time slot and the measured channel response in the reference time slot over a respective one of plurality of subcarriers and where the second time slot is part of the set of time slots, and where the composite phase offset value is based on the additional plurality of phase offsets.

According to another aspect of the present disclosure, the determining of the composite phase offset value includes selecting a maximum absolute phase offset value over all DMRS subcarriers.

According to another aspect of the present disclosure, the determining of the composite phase offset value includes calculating a root mean square of maximum phase offset values for each of the plurality of time slots.

According to another aspect of the present disclosure, the determining of the composite phase offset value includes determining a percentile ranking of the phase offsets of the plurality of time slots where the composite phase offset value corresponds to a phase offset value associated with a predefined percentile ranking.

According to another aspect of the present disclosure, the plurality of subcarriers are associated with a phase offset measurement.

According to another aspect of the present disclosure, the measuring of the plurality of channel responses are based on uplink transmissions from the wireless device in the plurality of time slots.

According to another aspect of the present disclosure, the uplink transmissions correspond to repetitions of physical channel transmissions among which the wireless device is configured to control relative phase associated with the physical channel transmissions.

According to another aspect of the present disclosure, at least one of the wireless device transmission coherence performance and the composite phase offset value is reported.

According to another aspect of the present disclosure, the plurality of channel responses associated with the plurality of subcarriers in the plurality of time slots does not include channel responses at a frequency band edge.

According to another aspect of the present disclosure, a method implemented by a wireless device is provided. Uplink transmission is caused on a plurality of subcarriers in a plurality of time slots for wireless device transmission coherence performance determination by the network node based on a plurality of channel responses associated with the uplink transmission where the wireless device transmission coherence performance determination is based on a composite phase offset value derived in part from the plurality of channel responses. The uplink transmission includes a repetition of a physical channel in the plurality of time slots where the wireless device controls the relative phase among the uplink transmissions in the time slots.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system according to principles disclosed herein;

FIG. 2 is a block diagram of a network node in communication with a wireless device over a wireless connection according to some embodiments of the present disclosure;

FIG. 3 is a flowchart of an example process in a network node for testing wireless device coherence transmission related to joint channel estimation according to some embodiments of the present disclosure;

FIG. 4 is a flowchart of an example process in a testing device according to some embodiments of the present disclosure;

FIG. 5 is a flowchart of an example process in a wireless device according to some embodiments of the present disclosure; and

FIG. 6 is a diagram defining a measurement point for phase offset for DMRS bundling according to some embodiments of the present disclosure.

### DETAILED DESCRIPTION

Before describing in detail example embodiments, it is noted that the embodiments reside primarily in combinations of apparatus components and processing steps related to testing wireless device (WD) coherence transmission related to joint channel estimation. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments are directed to testing wireless device (WD) coherence transmission related to joint channel estimation.

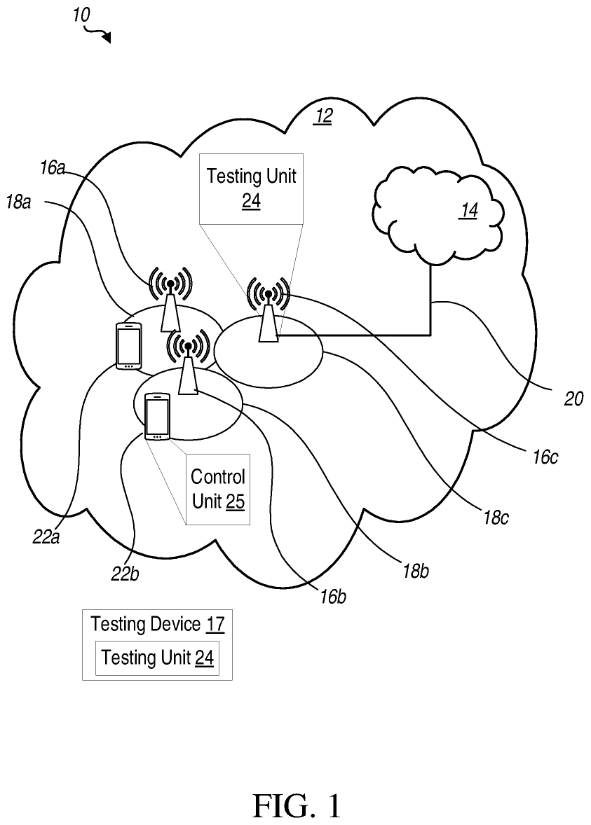

Referring to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, and one or more testing devices 17. Each network node 16 may define a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16, more than one type of network node 16, testing device 17, etc. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

A network node 16 (eNB or gNB) is configured to include a testing unit 24 that is configured to perform one or more network node 16 functions as described herein such as with respect to wireless device coherence transmission estimation. In one or more embodiments, testing unit 24 is configured to provide carrier frequency offset (CFO) compensation after fast Fourier transform (FFT) processing based on a determined magnitude distortion variation or phase distortion variation. WD 22 is configured to include control unit 25 for performing one or more wireless device functions described herein such as with respect to controlling relative phase among transmissions in time slots as described herein.

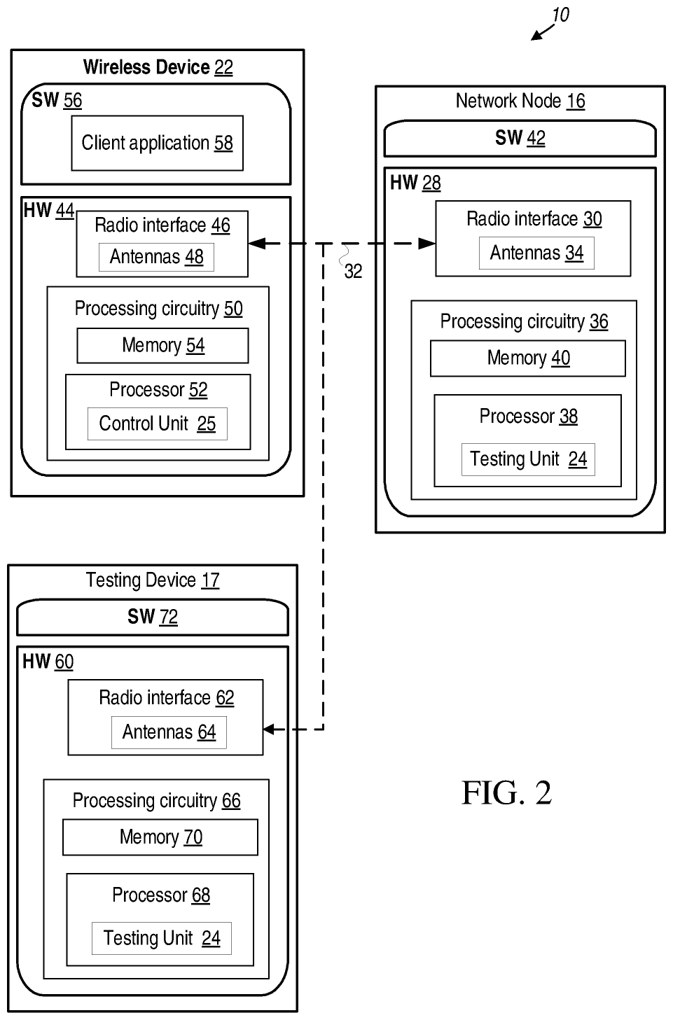

Example implementations, in accordance with an embodiment, of the WD 22, testing device 17 and network node 16 discussed in the preceding paragraphs will now be described with reference to FIG. 2.

The communication system 10 includes a network node 16 provided in a communication system 10 and including hardware 28 enabling it to communicate with the WD 22, testing device 17 and/or other entities in system 10. The hardware 28 may include a radio interface 30 for setting up and maintaining at least a wireless connection 32 with a WD 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16. For example, processing circuitry 36 of the network node 16 may include a testing unit 24 which is configured to, for example, provide carrier frequency offset (CFO) compensation after fast Fourier transform (FFT) processing based on a determined magnitude distortion variation or phase distortion variation.

The communication system 10 further includes the WD 22 already referred to. The WD 22 may have hardware 44 that may include a radio interface 46 configured to set up and maintain a wireless connection 32 with a network node 16 serving a coverage area 18 in which the WD 22 is currently located, and/or with testing device 17. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22. For example, processing circuitry 50 of WD 22 may include a control unit 25 which is configured to, for example, perform one or more WD 22 functions as described herein such as control relative phase among transmissions in time slots.

The communication system 10 includes a testing device 17 provided in a communication system 10 and including hardware 60 enabling it to communicate with the WD 22, network node 16, among other devices in system 10. The hardware 60 may include a radio interface 62 for setting up and maintaining at least a wireless connection 32 with a WD 22. The radio interface 62 may be formed as or may include, for example, one or more RF transmitters, one or more RF receivers, and/or one or more RF transceivers. The radio interface 62 includes an array of antennas 64 to radiate and receive signal(s) carrying electromagnetic waves.

In the embodiment shown, the hardware 60 of the testing device 17 further includes processing circuitry 66. The processing circuitry 66 may include a processor 68 and a memory 70. In particular, in addition to or instead of a processor, such as a central processing unit, and memory, the processing circuitry 66 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 68 may be configured to access (e.g., write to and/or read from) the memory 70, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the testing device 17 further has software 72 stored internally in, for example, memory 70, or stored in external memory (e.g., database, storage array, network storage device, etc.) accessible by the testing device 17 via an external connection. The software 72 may be executable by the processing circuitry 66. The processing circuitry 66 may be configured to control any of the methods and/or processes described herein and/or to cause such methods, and/or processes to be performed, e.g., by testing device 17. Processor 68 corresponds to one or more processors 68 for performing testing device 17 functions described herein. The memory 70 is configured to store data, programmatic software code and/or other information described herein. In some embodiments, the software 72 may include instructions that, when executed by the processor 68 and/or processing circuitry 66, causes the processor 68 and/or processing circuitry 66 to perform the processes described herein with respect to testing device 17. For example, processing circuitry 66 of the testing device 17 may include a testing unit 24 which is configured to perform one or more testing device 17 functions as described herein such as with respect to wireless device coherence transmission.

In some embodiments, the inner workings of the network node 16, testing device 17 and WD 22 may be as shown in FIG. 2 and independently, the surrounding network topology may be that of FIG. 1.

The wireless connection 32 among the WD 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Further, while testing device 17 is shown as being part of communication system 10, in one or more embodiments testing device 17 may not be part of a communication system 10 as testing device 17 may be configured to communicate with wireless device 22 and not with network node 16. Further, in one example, testing device 17 and wireless device 22 may be part of a testing environment that is not part of communication system 10.

Although FIGS. 1 and 2 show various “units” such as testing unit 24 and control unit 25 as being within a respective processor, it is contemplated that these units may be implemented such that a portion of the unit is stored in a corresponding memory within the processing circuitry. In other words, the units may be implemented in hardware or in a combination of hardware and software within the processing circuitry.

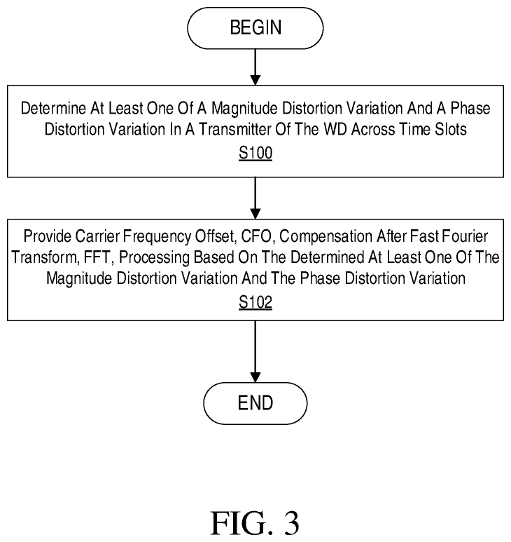

FIG. 3 is a flowchart of an example process in a network node 16 for testing wireless device (WD) coherence transmission related to joint channel estimation. One or more blocks described herein may be performed by one or more elements of network node 16 such as by one or more of processing circuitry 36 (including the testing unit 24), processor 38, and/or radio interface 30. Network node 16 is configured to determine at least one of a magnitude distortion variation and a phase distortion variation in a transmitter of the WD across time slots (Block S100). The process also includes providing carrier frequency offset, CFO, compensation after fast Fourier transform, FFT, processing based on the determined at least one of the magnitude distortion variation and the phase distortion variation (Block S102).

In some embodiments, determining the at least one of the magnitude and phase distortion variation includes determining a phase offset having a highest absolute value among phase offsets measured for each of a plurality of demodulation reference signal, DMRS, subcarriers. In some embodiments, determining the at least one of the magnitude and phase distortion variation includes testing transmissions on a plurality of resource blocks covering a channel bandwidth of the WD. In some embodiments, determining the at least one of the magnitude and phase distortion variation includes averaging a plurality of phase offsets on different resource blocks. In some embodiments, determining the at least one of the magnitude and phase distortion variation includes sorting a plurality of channel measurements and selecting a smallest channel measurement not less than a specified percentile. In some embodiments, determining the at least one of the magnitude and phase distortion variation includes sorting a plurality of channel measurements and selecting a largest channel measurement not greater than a specified percentile. In some embodiments, determining the at least one of the magnitude and phase distortion variation includes calculating a channel response based on a plurality of measurements across multiple slots.

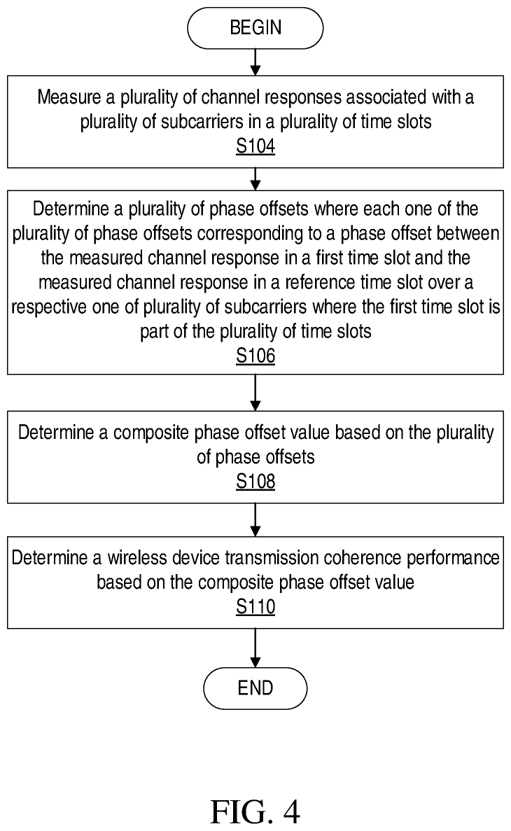

FIG. 4 is a flowchart of an example process in testing device 17 according to some embodiments of the present disclosure. One or more blocks described herein may be performed by one or more elements of testing device 17 such as by one or more of processing circuitry 66 (including the testing unit 24), processor 68, and/or radio interface 62. Testing device 17 is configured to measure (Block S104) a plurality of channel responses associated with a plurality of subcarriers in a plurality of time slots, as described herein. Testing device 17 is configured to determine (Block S106) a plurality of phase offsets where each one of the plurality of phase offsets corresponds to a phase offset between the measured channel response in a first time slot and the measured channel response in a reference time slot over a respective one of plurality of subcarriers, and where the first time slot is part of the plurality of time slots, as described herein. Testing device 17 is configured to determine (Block S108) a composite phase offset value based on the plurality of phase offsets, as described herein. Testing device 17 is configured to determine (Block S110) a wireless device transmission coherence performance based on the composite phase offset value.

According to one or more embodiments, the processing circuitry 66 is further configured to select a maximum value of the plurality of phase offsets associated with the first time slot.

According to one or more embodiments, the processing circuitry 66 is further configured to determine an additional plurality of phase offsets where each one of the additional plurality of phase offsets corresponds to a phase offset between the measured channel response in a second time slot and the measured channel response in the reference time slot over a respective one of plurality of subcarriers, and where the second time slot is part of the set of time slots, and where the composite phase offset value is based on the additional plurality of phase offsets.

According to one or more embodiments, the determining of the composite phase offset value includes selecting a maximum absolute phase offset value over all DMRS subcarriers.

According to one or more embodiments, the determining of the composite phase offset value includes calculating a root mean square of maximum phase offset values for each of the plurality of time slots.

According to one or more embodiments, the determining of the composite phase offset value includes determining a percentile ranking of the phase offsets of the plurality of time slots where the composite phase offset value corresponds to a phase offset value associated with a predefined percentile ranking.

According to one or more embodiments, the plurality of subcarriers are associated with a phase offset measurement.

According to one or more embodiments, the measuring of the plurality of channel responses are based on uplink transmissions from the wireless device 22 in the plurality of time slots.

According to one or more embodiments, the uplink transmissions correspond to repetitions of physical channel transmissions among which the wireless device 22 is configured to control relative phase associated with the physical channel transmissions.

According to one or more embodiments, the processing circuitry 66 is further configured to report at least one of the wireless device transmission coherence performance and the composite phase offset value.

According to one or more embodiments, the plurality of channel responses associated with the plurality of subcarriers in the plurality of time slots does not include channel responses at a frequency band edge.

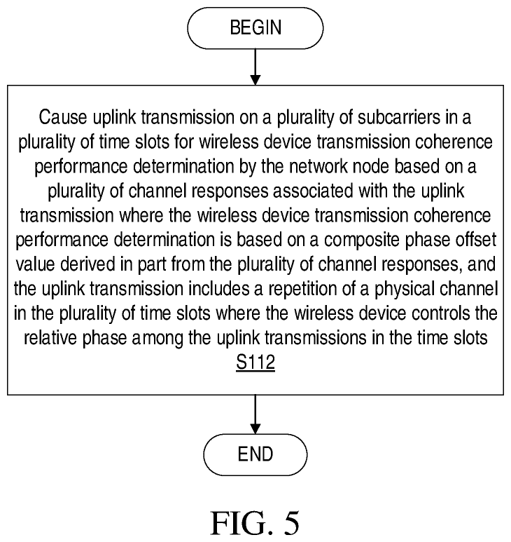

FIG. 5 is a flowchart of an example process in WD 22 according to some embodiments of the present disclosure. One or more blocks described herein may be performed by one or more elements of WD 22 such as by one or more of processing circuitry 50 (including the control unit 25), processor 52, and/or radio interface 46. WD 22 is configured to cause (Block S112) uplink transmission on a plurality of subcarriers in a plurality of time slots for wireless device transmission coherence performance determination by the network node 16 based on a plurality of channel responses associated with the uplink transmission where the wireless device transmission coherence performance determination is based on a composite phase offset value derived in part from the plurality of channel responses. The uplink transmission comprises a repetition of a physical channel in the plurality of time slots where the wireless device controls the relative phase among the uplink transmissions in the time slots.

Having described the general process flow of arrangements of the disclosure and having provided examples of hardware and software arrangements for implementing the processes and functions of the disclosure, the sections below provide details and examples of arrangements for testing wireless device (WD) coherence transmission related to joint channel estimation.

One or more testing device 17 function described below may be performed by one or more of processing circuitry 66, processor 68, testing unit 24, radio interface 62, etc. Alternatively, one or more network node 16 functions described below may be performed by one or more of processing circuitry 36, processor 38, testing unit 24, etc.

In some embodiments, an UL transmission in slots to be tested may be a PUSCH/PUCCH transmission or a PUSCH/PUCCH repetition, or different parts of a TB transmission on PUSCH (transport block over multiple slots), or different UL transmissions with different contents scheduled by configured grants or by dynamic grant (can be a single dynamic grant scheduling multi-PUSCH or be multiple dynamic grants).

As the frequency response over the WD channel bandwidth may not be flat, to save the test time and test the whole frequency range over the configured WD channel bandwidth, the full resource block (RB) allocation over the WD channel bandwidth may be configured. Therefore, for the phase offset over the configured WD channel bandwidth, the maximum phase offset in absolute value among the phase offset measured for each DMRS subcarrier may be selected. In this way, the WD may meet the phase tolerance requirement over the full frequency range within a band. The network node may schedule any RB position with the consistent WD phase tolerance performance over the whole WD bandwidth. Another embodiment includes testing with transmissions in a limited number of RBs and with repeated transmissions in different RBs that then cover the full channel bandwidth. Another embodiment includes averaging the phase offset within a set of RBs (1 RB or several RB, or some other number of subcarriers) so that phase offsets with different RB sets could be measured, and the maximum value among these phase offsets may be selected as a final phase offset for this time slot.

In yet another embodiment, the maximum operation could be replaced by taking the value at some percentile, e.g., the N^{th} percentile. This has an advantage of being more robust by reducing the impact of outliers. This is achieved by collecting all the measurements, and by sorting the obtained measurement values, selecting the smallest measurement value such that N % of the measurement values are smaller than the selected value, or select the largest measurement value such that (100−N) % of the measurement values are larger than the selected value. N may be, for example, 95, representing the 95^{th} percentile. This embodiment may also be described as deriving the cumulative density function (CDF) of the measurements and selecting the Nth percentile based on it. The set of measurements can be the set of measurements for different frequencies for one pair of slots, or it can be a set of measurements from multiple slot pairs.

One example measurement procedure is described for the phase difference measurement for DMRS bundling according to the steps below.
1. Prepare the modified measured data after FFT:
   The post-FFT modulated signal before the equalization is modified according to:

$${Z}^{″} ( t , f ) = F F T \{ z ( v - Δ \tilde{t} ) \cdot {e}^{- j 2 πΔ \overline{f} v} \} . {e}^{j 2 π f Δ \tilde{t}}$$

where
z(v) are the time domain samples of the signal under test within the bundled time slots.
To minimize the error, the signal under test may be modified with respect to a set of parameters following the procedure explained below.
Notation:
Δ\tilde{t} is the sample timing difference between the FFT processing window in relation to nominal timing of the ideal signal.
Δ\tilde{f} is the RF frequency offset.
To minimize the error, the error vector magnitude (EVM) window estimation is reused for the phase difference measurement for DMRS bundling.
In the following, Δ\tilde{c} represents the middle sample of the EVM window of length W or the last sample of the first window half if W is even.
The test equipment may be configured to:
   detect the start of each slot and estimate Δ\tilde{t} and Δ\tilde{f};
   determine Δ\tilde{c} so that the EVM window of length W is centered;
   on the time interval determined by the measured cyclic prefix minus 16K samples of the considered orthogonal frequency division multiplexed (OFDM) symbol for symbol 1 for subcarrier spacing configuration u in a subframe, with 1=0 or 1=7*2\hat{ }μ for normal cyclic prefix (CP), i.e., the first 16K samples of the CP should not be taken into account for this step. In the determination of the number of excluded samples, a sampling rate of 1/T_{c} is assumed. If a different sampling rate is used, the number of excluded samples is scaled linearly.
   on the measured cyclic prefix of the considered OFDM symbol for all other symbols for normal CP and for symbol 0 to 11 for extended CP.
To determine the other parameters, a sample timing offset equal to Δ\tilde{c} may be corrected from the signal under test. The test equipment may then:
   correct the RF frequency offset Δ\tilde{f} for each time slot within the bundled time slots; and
   apply an FFT of appropriate size. The chosen FFT size may ensure that in the case of an ideal signal under test, there is no measured inter-subcarrier interference.
The carrier leakage may be removed from the evaluated signal;
however, the removed relative carrier leakage power should also satisfy the applicable requirement.
   At this stage, estimates of Δ\tilde{f}, ã(t, f), \tilde{ϕ}(t, f) and Δ\tilde{c} are available. At may be one of the extremities of the window W, i.e., Δ\tilde{t} can be

$$Δ \tilde{c} + α - ⌊ \frac{W}{2} ⌋ or Δ \tilde{c} + ⌊ \frac{W}{2} ⌋ ,$$

where α=0 if W is odd and α=1 if W is even. The test equipment may then:
   calculate PhaseOffsetₗ with Δ\tilde{t} set to

$$Δ \tilde{c} + α - ⌊ \frac{W}{2} ⌋ ;$$

and/or
calculate PhaseOffsetₕ with Δ\tilde{t} set to

$$Δ \tilde{c} + ⌊ \frac{W}{2} ⌋ .$$

2. Calculate the channel response of the TX chain
   Calculate the complex ratios (amplitude and phase) of the post-FFT acquired signal Z″(t, f) and the post-FFT ideal reference signal I(t, f), for each reference signal, over one measurement interval of one time slot. This process creates a set of complex ratios of the channel coefficient:

$$H ( t , f ) = α ( t , f ) \cdot {e}^{j φ ( t , f )} = \frac{{Z}^{′} ( t , f )}{I ( t , f )}$$

where the post-FFT ideal signal I(t, f) is a DMRS reference signal within one time slot.
   Perform time averaging of the phase φ(t, f) at each reference signal subcarrier of the channel coefficient, the time-averaging length is total number of N DMRS symbols over one time slot.

$$\tilde{φ} ( f ) = \frac{{\sum }_{t} φ ( t , f )}{N} = \frac{{\sum }_{t} {tan}^{- 1} \frac{Im ( H ( t , f ) )}{Re ( H ( t , f ) )}}{N}$$

Re (H(t,f)) is the real part of the complex-valued H(t,f) and Im (H(t,f)) is the imaginary part of the complex-valued H(t,f). tan⁻¹ is the inverse of the tangent function.
3. Phase offset measurement
   For the reference time slot Tr, the phase of the complex-valued channel coefficient is calculated as \tilde{φ}(f) in Annex F.9.2 with channel coefficient H_{\tilde{φ}}(t, f).
   For the time slot Ti, the phase of complex-valued channel coefficient is calculated as \tilde{θ}(f) in step 2 with channel coefficient H_{\tilde{θ}(t, f).}
   For the phase offset measurement between this time slot and the reference time slot, the PhaseOffset (Ti) is defined as below:

$$\begin{matrix}PhaseOffset ( Ti ) = {max}_{f} ( \vert \tilde{φ} ( f ) - \tilde{θ} ( f ) \vert ) \\ = {max}_{f} \vert ( \frac{{\sum }_{t} {tan}^{- 1} \frac{Im ( {H}_{\tilde{θ}} ( t , f ) \cdot {{H}_{\tilde{φ}} ( t , f )}^{*} )}{Re ( {H}_{\tilde{θ}} ( t , f ) \cdot {{H}_{\tilde{φ}} ( t , f )}^{*} )}}{N} ) \vert\end{matrix}$$

The phase offset measurement of PhaseOffset (Ti) is selected as the maximum absolute value over all DMRS subcarriers and averaged over N DMRS symbols in one time slot. H_{\tilde{φ}}(t, f)* is the complex conjugate of H_{\tilde{φ}}(t, f).
The measurement may be done within all bundled time slots except the reference time slot and repeated over 10 bundles. The rms value of phase offset may be calculated with the following equation assuming the total number of measurement samples is L.

$$P h aseOffse {t}_{r m s} = \sqrt{\frac{{\sum }_{1}^{L} {PhaseOffset ( Ti )}^{2}}{L}}$$

Finally, the PhaseOffset measurement may be tested against the maximum of the RMS average at the window W extremities of the measurements:
P̅h̅a̅s̅e̅O̅f̅f̅s̅e̅t̅ₗ̅ is calculated using Δ\tilde{t}=Δ\tilde{t}ₗ in the expressions above and P̅h̅a̅s̅e̅O̅f̅f̅s̅e̅t̅ₕ̅ is calculated using Δ\tilde{t}=Δ\tilde{t}ₕ.
Thus:

PhaseOffset=max(P̅h̅a̅s̅e̅O̅f̅f̅s̅e̅t̅ₗ̅,P̅h̅a̅s̅e̅O̅f̅f̅s̅e̅t̅ₕ̅)

It may be noted that the term ‘time slots’ in the steps above can be according to the unit of slots used to characterize a radio frame in 3GPP TS 38.211 rev. 17.0.0. Or time slots may differ in meaning, For example, each time slot herein may correspond to an OFDM symbol. Consequently, bundled time slots correspond to those OFDM symbols for which the WD should maintain relative phase. Such bundled time slots can be identified using the 3GPP TS 38.211 unit of slots as slots in which a WD should transmit a physical channel with phase continuity or phase continuity and power consistency. Such slots may be identified, for example, as slots within an actual time domain window or in a nominal time domain window using the terminology of 3GPP TS 38.214 rev 17.0.0.

A benefit of some of the methods above of calculating the phase offset using a reference time slot when a single time slot is used as the reference slot is that carrier frequency offset is not canceled in the phase offset calculation. Measurement time slots that are further away from the reference time slot will have a larger phase offset induced by the carrier frequency offset. In this way, the impact of carrier frequency offset may be more easily measured. This benefit is useful assuming that such carrier frequency offset is not automatically removed by the test equipment or receiving network node.

Another benefit of some of the methods above may be obtained when calculating the phase offset using a reference time slot that is immediately previous time slot to the measurement time slot can be that carrier frequency offset is canceled in the phase offset calculation. Since the time slots are close together, carrier frequency offset will have a minimal effect on the phase offset. This benefit is useful assuming that such carrier frequency offset is automatically removed by the test equipment or receiving network node.

Therefore, in a general embodiment, a testing device 17 determines WD transmission coherence performance in terms of the phase variation by measuring a channel response in subcarriers in each of a set of time slots. The set of time slots comprises slots in which the WD transmits repetitions of a physical channel among which the WD should control relative phase. Such time slots may be referred to as bundled time slots, or time slots within a nominal time window or an actual time window. The testing device determines a phase offset between the measured channel response in a time slot K of the set of time slots and the measured channel response in a reference time slot K0 over a plurality of occupied subcarriers of the DMRS symbol. It further determines a composite phase offset value from the phase offsets in at least the time slot K. The testing device also reports at least one of the composite phase offset and if a test is passed according to the value of the composite phase offset.

Some embodiments further comprise repeating the step of determining the phase offset in time slot K for the set of time slots, and determining the composite phase offset from the phase offsets in the set of time slots.

In some embodiments, the step of determining a composite phase offset further comprises choosing the maximum value of phase offset among all the phase offsets determined for time slot K. This may be expressed as the following using the notation above:

$$PhaseOffset ( Ti ) = {max}_{f} ( \vert \tilde{φ} ( f ) - \tilde{θ} ( f ) \vert ) = {max}_{f} \vert ( \frac{{\sum }_{t} {tan}^{- 1} \frac{Im ( {H}_{\tilde{θ}} ( t , f ) \cdot {{H}_{\tilde{φ}} ( t , f )}^{*} )}{Re ( ( {H}_{\tilde{θ}} ( t , f ) \cdot {{H}_{\tilde{φ}} ( t , f )}^{*} )}}{N} ) \vert$$

Embodiments that repeat the step of determining the phase offset and that choose the maximum value of phase offset may further comprise calculating a maximum phase offset from the phase offsets determined for the time slot K and calculating the composite phase offset value as the root mean square of the maximum phase offsets for each time slot K in the set of time slots. The step of calculating the root mean square may expressed as the following using the notation above.

$$PhaseOffse {t}_{r m s} = \sqrt{\frac{{\sum }_{1}^{L} {PhaseOffset ( Ti )}^{2}}{L}}$$

Other embodiments that repeat the step of determining the phase offset may further comprise determining a percentile ranking of the phase offset values in the plurality of time slots and determining the composite phase offset value as the value having the percentile ranking. Determine the percentile ranking can comprise the procedures to determine the Nth percentile as described above.

In other embodiments, some of the above expressions are further refined. For example, one may use the complex logarithm instead of tan⁻¹ to handle angles outside the range −90 degrees to +90 degrees correctly:

$$\tilde{φ} ( f ) = \frac{{\sum }_{t} φ ( t , f )}{N} = \frac{{\sum }_{t} Im [ log ( H ( t , f ) ) ]}{N}$$

The branch cut of the complex logarithm function can here be set to the negative real axis. The angle will be in radians. Furthermore, the averaging can be performed in the complex domain instead of in the angle domain to increase the robustness by giving H(t, f) values with small magnitude (and which might hence have a potentially very large angle error) less weight, e.g.:

$$\tilde{φ} ( f ) = angle \{ \frac{{\sum }_{t} H ( t , f )}{N} \} ,$$

where angle (z) denotes a function yielding the angle in the complex plane, e.g., Im(log(z)) or

$${tan}^{- 1} \frac{Im ( z )}{Re ( z )} .$$

Analogous approaches can be used also to the calculation of angle difference, e.g.:

$$PhaseOffset ( Ti ) = {max}_{f} ( \vert \tilde{φ} ( f ) - \tilde{θ} ( f ) \vert ) = {max}_{f} \vert \frac{{\sum }_{t} angle [ ( {H}_{\tilde{θ}} ( t , f ) \cdot {{H}_{\tilde{φ}} ( t , f )}^{*} ) ]}{N} \vert \cdot$$

where the angle function is defined according to any of the aforementioned expressions. One may also use an average operation instead of the maximum operation. One may alternatively perform the average in the complex domain instead of the angle domain, e.g.:

$$PhaseOffset ( Ti ) = \vert angle \{ \frac{{\sum }_{f} {\sum }_{t} {H}_{\overline{θ}} ( t , f ) \cdot {{H}_{\tilde{φ}} ( t , f )}^{*}}{N \cdot {N}_{f}} \} \vert ,$$

where N_{f} is the number of frequencies f averaged over. Note also that which of the two H's is conjugated does not matter due to the absolute value operation. As discussed above, an alternative to averaging or max could be a mixture, where averaging is performed e.g. within on PRB (or some other subcarrier range), and a maximum (or percentile value) of the results is taken.
Some non-limiting example embodiments may include one or more of the following:
1. Method to determine WD transmission coherence performance in terms of the phase variation comprising:
   a. Measuring/calculating/determining a channel response in subcarriers in each of a set of time slots
   b. Determining a phase offset between the measured channel response in a time slot K of the set of time slots and the measured channel response in a reference time slot K0 over a plurality of occupied subcarriers of the DMRS symbol
   c. Determining a composite phase offset value from the phase offsets in at least the time slot K
   d. Reporting at least one of the composite phase offset and if a test is passed according to the value of the composite phase offset
2. The method of 1, wherein the step of determining a composite phase offset further comprises:
   a. Choosing the maximum value of phase offset among all the phase offsets determined for time slot K
3. The method of 1 or 2 further comprising
   a. Repeating the step of determining the phase offset in time slot K for the set of time slots, and
   b. determining the composite phase offset from the phase offsets in the set of time slots.
4. The method of 3, further comprising
   a. Calculating a maximum phase offset from the phase offsets determined for the time slot K, and
   b. Calculating the composite phase offset value as the root mean square of the maximum phase offsets for each time slot K in the set of time slots
5. The method of 4, further comprising
   a. Determining a percentile ranking of the phase offset values in the plurality of time slots, and
   b. Determining the composite phase offset value as the value having the percentile ranking

Some embodiments provide a methodology to test TX RF hardware coherence transmission.

### Some Additional Non-Limiting Examples

Example A1. A network node 16 configured to communicate with a wireless device 22 (WD 22), the network node 16 configured to, and/or comprising a radio interface 30 and/or comprising processing circuitry 36 configured to:
determine at least one of a magnitude distortion variation and a phase distortion variation in a transmitter of the WD 22 across time slots; and
provide carrier frequency offset, CFO, compensation after fast Fourier transform, FFT, processing based at least in part on the determined at least one of the magnitude distortion variation and the phase distortion variation.
Example A2. The network node 16 of Example A1, wherein determining the at least one of the magnitude and phase distortion variation includes determining a phase offset having a highest absolute value among phase offsets measured for each of a plurality of demodulation reference signal, DMRS, subcarriers.
Example A3. The network node 16 of any of Examples A1 and A2, wherein determining the at least one of the magnitude and phase distortion variation includes testing transmissions on a plurality of resource blocks covering a channel bandwidth of the WD 22.
Example A4. The network node 16 of any of Examples A1-A3, wherein determining the at least one of the magnitude and phase distortion variation includes averaging a plurality of phase offsets on different resource blocks.
Example A5. The network node 16 of any of Examples A1-A4, wherein determining the at least one of the magnitude and phase distortion variation includes sorting a plurality of channel measurements and selecting a smallest channel measurement not less than a specified percentile.
Example A6. The network node 16 of any of Examples A1-A4, wherein determining the at least one of the magnitude and phase distortion variation includes sorting a plurality of channel measurements and selecting a largest channel measurement not greater than a specified percentile.
Example A7. The network node 16 of any of Examples A1-A6, wherein determining the at least one of the magnitude and phase distortion variation includes calculating a channel response based at least in part on a plurality of measurements across multiple slots.
Example B1. A method implemented in a network node 16 that is configured to communicate with a wireless device 22, the method comprising:
determining at least one of a magnitude distortion variation and a phase distortion variation in a transmitter of the WD 22 across time slots; and
providing carrier frequency offset, CFO, compensation after fast Fourier transform, FFT, processing based at least in part on the determined at least one of the magnitude distortion variation and the phase distortion variation.
Example B2. The method of Example B1, wherein determining the at least one of the magnitude and phase distortion variation includes determining a phase offset having a highest absolute value among phase offsets measured for each of a plurality of demodulation reference signal, DMRS, subcarriers.
Example B3. The method of any of Examples B1 and B2, wherein determining the at least one of the magnitude and phase distortion variation includes testing transmissions on a plurality of resource blocks covering a channel bandwidth of the WD.
Example B4. The method of any of Examples B1-B3, wherein determining the at least one of the magnitude and phase distortion variation includes averaging a plurality of phase offsets on different resource blocks.
Example B5. The method of any of Examples B1-B4, wherein determining the at least one of the magnitude and phase distortion variation includes sorting a plurality of channel measurements and selecting a smallest channel measurement not less than a specified percentile.
Example B6. The method of any of Examples B1-B4, wherein determining the at least one of the magnitude and phase distortion variation includes sorting a plurality of channel measurements and selecting a largest channel measurement not greater than a specified percentile.
Example B7. The method of any of Examples B1-B6, wherein determining the at least one of the magnitude and phase distortion variation includes calculating a channel response based at least in part on a plurality of measurements across multiple slots.

### Standardizing the Proposed Embodiments

Below are additional non-limiting examples of how certain aspects of the proposed embodiments could be implemented within the framework of a specific communication standard. In particular, the below description provides non-limiting examples of how the proposed embodiments could be implemented within the framework of a 3GPP TSG RAN standard. The changes described below are merely intended to illustrate how certain aspects of the proposed embodiments could be implemented in a particular standard. However, the proposed embodiments could also be implemented in other suitable manners, both in the 3GPP Specification and in other specifications or standards.

### Standardizing Example 1 Associated with 3GPP 38.101-2

### 5.3.5 Channel Bandwidth Per Operating Band

The requirements in this specification apply to the combination of channel bandwidths, SCS and operating bands shown in Table 5.3.5-1. The transmission bandwidth configuration in Table 5.3.2-1 shall be supported for each of the specified channel bandwidths. The channel bandwidths are specified for both the Tx and Rx path.

TABLE 5.3.5-1
Channel bandwidths for each NR band

| | | |
|---|---|---|
| Operating | SCS | UE channel bandwidth (MHz) |

| band | (kHz) | 50 | 100 | 200 | 400¹ |
|---|---|---|---|---|---|
| n257 | 60 | 50 | 100 | 200 | |
| | 120 | 50 | 100 | 200 | 400 |
| n258 | 60 | 50 | 100 | 200 | |
| | 120 | 50 | 100 | 200 | 400 |
| n259 | 60 | 50 | 100 | 200 | |
| | 120 | 50 | 100 | 200 | 400 |
| n260 | 60 | 50 | 100 | 200 | |
| | 120 | 50 | 100 | 200 | 400 |
| n261 | 60 | 50 | 100 | 200 | |
| | 120 | 50 | 100 | 200 | 400 |
| n262 | 60 | 50 | 100 | 200 | |
| | 120 | 50 | 100 | 200 | 400 |

NOTE 1:
This WD channel bandwidth is optional in this release of the specification.
NOTE 2:
For PC6 RedCap WD, the maximum channel bandwidth is 100 MHz.

### 6.2.1.0 General

NOTE: Power class 1, 2, 3, and 4 are specified based on the assumption of certain WD types with specific device architectures. The WD types can be found in Table 6.2.1.0-1.

TABLE 6.2.1.0-1
Assumption of WD Types

| WD Power class | WD type |
|---|---|
| 1 | Fixed wireless access (FWA) WD |
| 2 | Vehicular WD |
| 3 | Handheld WD |
| 4 | High power non-handheld WD |
| 5 | Fixed wireless access (FWA) WD |
| 6 | RedCap WD |

Power class 3 is default power class.

### 6.2.1.6 WD Maximum Output Power for Power Class 6

The following requirements define the maximum output power radiated by the WD for any transmission bandwidth within the channel bandwidth for non-CA configuration, unless otherwise stated. The period of measurement shall be at least one sub frame (1 ms). The minimum output power values for EIRP are found in Table 6.2.1.6-1. The requirement is verified with the test metric of total component of EIRP (Link=TX beam peak direction, Meas=Link angle).

TABLE 6.2.1.6-1
WD minimum peak EIRP for power class 6

| Operating | Min peak EIRP |
|---|---|
| band | (dBm) |
| n257 | [16.4] |
| n258 | [16.4] |
| n261 | [16.4] |

NOTE 1:
Minimum peak EIRP is defined as the lower limit without tolerance
NOTE 2:
Void

The maximum output power values for TRP and EIRP are found on the Table 6.2.1.6-2. The max allowed EIRP is derived from regulatory requirements. The requirements are verified with the test metrics of TRP (Link=TX beam peak direction, Meas=TRP grid) in beam locked mode and the total component of EIRP (Link-TX beam peak direction, Meas=Link angle.

TABLE 6.2.1.6-2
WD maximum output power limits for power class 6

| Operating | Max TRP | Max EIRP |
|---|---|---|
| band | (dBm) | (dBm) |
| n257 | 23 | 43 |
| n258 | 23 | 43 |
| n261 | 23 | 43 |

The minimum EIRP at the 50^{th} percentile of the distribution of radiated power measured over the full sphere around the WD is defined as the spherical coverage requirement and is found in Table 6.2.1.6-3 below. The requirement is verified with the test metric of the total component of EIRP (Link-Beam peak search grids, Meas=Link angle)

TABLE 6.2.1.6-3
WD spherical coverage for power class 6

| | Min EIRP at 50%-tile |
|---|---|
| Operating band | CDF (dBm) |
| n257 | [x] |
| n258 | [x] |
| n261 | [x] |

NOTE 1:
Minimum EIRP at 50%-tile CDF is defined as the lower limit without tolerance
NOTE 2:
The requirements in this table are verified only under normal temperature conditions as defined in Annex E.2.1.

### 6.2.2.6 UE Maximum Output Power Reduction for Power Class 6

For power class 6, MPR specified in sub-clause 6.2.2.3 of 3GPP 38.101 applies.

### 6.2.3.3.6 A-MPR for NS_202 for Power Class 6

For power class 6, A-MPR for NS_202 specified in clause 6.2.3.3.3 of 3GPP 38.101 applies.

### 6.2.3.4.6 A-MPR for NS_203 for Power Class 6

For power class 6, AMPR for NS_203 specified in subclause 6.2.3.4.3 of 3GPP 38.101 applies.

### 6.3.1.2 Minimum Output Power for Power Class 2, 3, 4 and 6

The minimum output power shall not exceed the values specified in Table 6.3.1.2-1 for each operating band supported. The minimum power is verified in beam locked mode with the test metric of EIRP (Link=TX beam peak direction, Meas=Link angle).

TABLE 6.3.1.2-1
Minimum output power for power class 2, 3, 4 and 6

| | Channel | Minimum | Measurement |
|---|---|---|---|
| | bandwidth | output power | bandwidth |
| Operating band | (MHz) | (dBm) | (MHz) |
| n257, n258, | 50 | −13 | 47.58 |
| n260, n261, | 100 | −13 | 95.16 |
| n262 | 200 | −13 | 190.20 |
| | 400 | −13 | 380.28 |

NOTE 1:
n260 is not applied for power class 2.
NOTE 2:
n259 is not applied for power class 2 and 4.
NOTE 3:
n260 and n262 is not applied for power class 6.

### 6.4.2.2.7 Carrier Leakage for Power Class 6

When carrier leakage is contained inside the spectrum occupied by the configured UL CCs and DL CCs, the relative carrier leakage power specified in subclause 6.4.2.2.4 of 3GPP 38.101 applies.

### 6.4.2.3.7 In-Band Emissions for Power Class 6

The average of the in-band emission specified in subclause 6.4.2.3.4 of 3GPP 38.101 applies.

### 6.6.7 Beam Correspondence for Power Class 6

The beam correspondence requirement specified in subclause 6.6.4 of 3GPP 38.101 applies.

### Standardizing Example 2 Associated with 3GPP 38.101-1

### Annex F.9 Phase Offset Measurement for DMRS Bundling

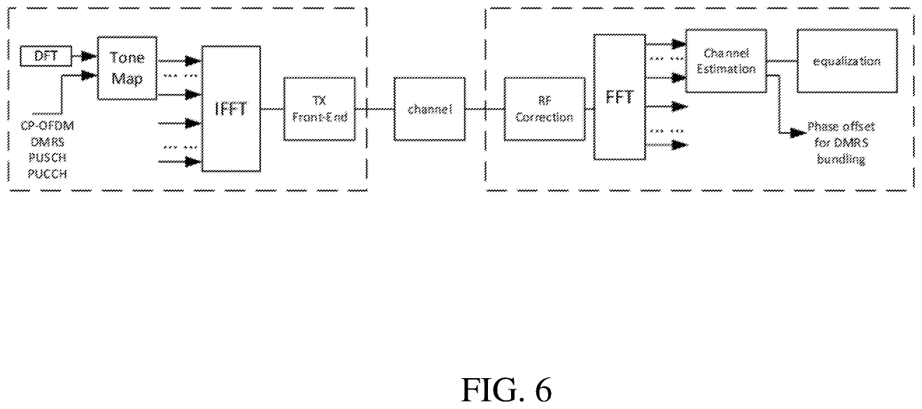

The measurement point for phase offset measurement for DMRS bundling is 4 in FIG. 6.

### Annex F.9.1 Modified Test Signal

The post-FFT modulated signal before the equalization is modified according to:

$${Z}^{″} ( t , f ) = F F T \{ z ( v - Δ \tilde{t} ) \cdot {e}^{- j 2 πΔ \tilde{f} v} \} . {e}^{j 2 π f Δ \tilde{t}}$$

where

z(v) is the time domain samples of the signal under test within the bundled time slots.

To minimize the error, the signal under test should be modified with respect to a set of parameters following the procedure explained below.

### Notation:

Δ\tilde{t} is the sample timing difference between the FFT processing window in relation to nominal timing of the ideal signal.

Δ\tilde{f} is the RF frequency offset.

To minimize the error, the EVM window estimation is reused for the phase difference measurement for DMRS bundling.

In the following Δ\tilde{c} represents the middle sample of the EVM window of length W or the last sample of the first window half if W is even.

The test equipment shall
detect the start of each slot and estimate Δ\tilde{t} and Δ\tilde{f},
determine Δ\tilde{c} so that the EVM window of length W is centred
   on the time interval determined by the measured cyclic prefix minus 16κ samples of the considered OFDM symbol for symbol 1 for subcarrier spacing configuration u in a subframe, with 1=0 or 1=7*2\hat{ }μ for normal CP, i.e. the first 16κ samples of the CP should not be taken into account for this step. In the determination of the number of excluded samples, a sampling rate of 1/T_{c} is assumed. If a different sampling rate is used, the number of excluded samples is scaled linearly.
   on the measured cyclic prefix of the considered OFDM symbol for all other symbols for normal CP and for symbol 0 to 11 for extended CP.

To determine the other parameters a sample timing offset equal to Δ\tilde{c} is corrected from the signal under test. The test equipment shall then
correct the RF frequency offset Δ\tilde{f} for each time slot within the bundled time slots, and
apply an FFT of appropriate size. The chosen FFT size shall ensure that in the case of an ideal signal under test, there is no measured inter-subcarrier interference.

The carrier leakage shall be removed from the evaluated signal; however, the removed relative carrier leakage power also has to satisfy the applicable requirement.

At this stage estimates of Δ\tilde{f}, ã(t, f), \tilde{ϕ}(t, f) and Δ\tilde{c} are available. Δ\tilde{t} is one of the extremities of the window W, i.e. Δ\tilde{t} can be

$$Δ \tilde{c} + α - ⌊ \frac{W}{2} ⌋ or Δ \tilde{c} + ⌊ \frac{W}{2} ⌋ ,$$

where α=0 if W is odd and α=1 if W is even. The test equipment shall then
calculate PhaseOffsetₗ with Δ\tilde{t} set to

$$Δ \tilde{c} + α - ⌊ \frac{W}{2} ⌋ ,$$

calculate PhaseOffsetₕ with Δ\tilde{t} set to

$$Δ \tilde{c} + ⌊ \frac{W}{2} ⌋ .$$

### Annex F.9.2 Frequency Response of the TX Chain

Calculate the complex ratios (amplitude and phase) of the post-FFT acquired signal Z″(t, f) and the post-FFT ideal reference signal I(t, f), for each reference signal, over one measurement interval of one time slot. This process creates a set of complex ratios of the channel coefficient:

$$H ( t , f ) = α ( t , f ) \cdot {e}^{j φ ( t , f )} = \frac{{Z}^{′} ( t , f )}{I ( t , f )}$$

Where the post-FFT ideal signal I(t, f), is DMRS reference signal within one time slot.

Perform time averaging of the phase φ(t, f) at each reference signal subcarrier of the channel coefficient, the time-averaging length is total number of N DMRS symbols over one time slot.

$$\tilde{φ} ( f ) = \frac{{\sum }_{t} φ ( t , f )}{N} = \frac{{\sum }_{t} {tan}^{- 1} \frac{Im ( H ( t , f ) )}{R e ( H ( t , f ) )}}{N}$$

Re (H(t,f)) is the real part of the complex-valued H(t,f) and Im (H(t,f)) is the imaginary part of the complex-valued H(t,f).

### Annex F.9.3 Phase Offset Measurement

For the reference time slot Tr, the phase of complex-valued channel coefficient is calculated as \tilde{φ}(f) in Annex F.9.2 with channel coefficient H_{\tilde{φ}}(t, f).

For the time slot Ti, the phase of complex-valued channel coefficient is calculated as \tilde{θ}(f) in Annex F.9.2 with channel coefficient H_{\tilde{θ}}(t, f).

For the phase offset measurement between this time slot and the reference time slot, the PhaseOffset (Ti) is defined as below:

$$PhaseOffset ( Ti ) = {max}_{f} ( \vert \tilde{φ} ( f ) - \tilde{θ} ( f ) \vert ) = {max}_{f} \vert ( \frac{{\sum }_{t} {tan}^{- 1} \frac{Im ( {H}_{\tilde{θ}} ( t , f ) \cdot {{H}_{\tilde{φ}} ( t , f )}^{*} )}{Re ( {H}_{\tilde{θ}} ( t , f ) \cdot {{H}_{\tilde{φ}} ( t , f )}^{*} )}}{N} ) \vert P$$

The phase offset measurement of PhaseOffset (Ti) is selected as maximum absolute value over all DMRS subcarriers and averaged over N DMRS symbols in one time slot. H_{\tilde{φ}}(t, f)* is the complex conjugate of H_{\tilde{φ}}(t, f).

The measurement should be done within all bundled time slot except the reference time slot and repeated over bundles, the rms value of phase offset should be calculated with below equation assuming the total number of measurement sample is L.

$$PhaseOffse {t}_{r m s} = \sqrt{\frac{{\sum }_{1}^{L} {PhaseOffset ( Ti )}^{2}}{L}}$$

Finally, the PhaseOffset measurement shall be tested against the maximum of the RMS average at the window W extremities of the measurements:

Thus P̅h̅a̅s̅e̅O̅f̅f̅s̅e̅t̅ₗ̅ is calculated using Δ\tilde{t}=Δ\tilde{t}ₗ in the expressions above and P̅h̅a̅s̅e̅O̅f̅f̅s̅e̅t̅ₕ̅ is calculated using Δ\tilde{t}=Δ\tilde{t}ₕ.

### Thus we get:

$$PhaseOffset = max ( \overline{{PhaseOffset}_{l}} , \overline{{PhaseOffset}_{h}} )$$

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
CFO Carrier Frequency Offset
DFT Discrete Fourier Transform
EVM Error Vector Magnitude

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A testing device configured to communicate with a wireless device, the testing device comprising:
processing circuitry configured to:
measure a plurality of channel responses associated with a plurality of subcarriers in a plurality of time slots, the plurality of channel responses being from the wireless device;
determine a plurality of phase offsets, each one of the plurality of phase offsets corresponding to a phase offset between the measured channel response in a first time slot and the measured channel response in a reference time slot over a respective one of plurality of subcarriers, the first time slot being part of the plurality of time slots; and
determine a composite phase offset value based on the plurality of phase offsets.

2. (canceled)

3. The testing device of claim 1, wherein the processing circuitry is further configured to determine a wireless device transmission coherence performance based on the composite phase offset value.

4. The testing device of claim 1, wherein the determining of the composite phase offset value includes selecting a maximum absolute phase offset value over all demodulation reference signal (DMRS) subcarriers.

5. The testing device of claim 1, wherein the determining of the composite phase offset value includes calculating a root mean square of maximum phase offset values for each of the plurality of time slots.

6. (canceled)

7. The testing device of claim 1, wherein the plurality of subcarriers are associated with a phase offset measurement.

8. The testing device of claim 1, wherein the plurality of time slots are within a time domain window for bundling demodulation reference signal (DMRS).

9.-12. (canceled)

13. A method implemented by a testing device that is configured to communicate with a wireless device, the method comprising:
measuring a plurality of channel responses associated with a plurality of subcarriers in a plurality of time slots, the plurality of channel responses being from the wireless device;
determining a plurality of phase offsets, each one of the plurality of phase offsets corresponding to a phase offset between the measured channel response in a first time slot and the measured channel response in a reference time slot over a respective one of plurality of subcarriers, the first time slot being part of the plurality of time slots; and
determining a composite phase offset value based on the plurality of phase offsets.

14. (canceled)

15. The method of claim 13, further comprising determining a wireless device transmission coherence performance based on the composite phase offset value.

16. The method of claim 13, wherein the determining of the composite phase offset value includes selecting a maximum absolute phase offset value over all demodulation reference signal (DMRS) subcarriers.

17. The method of claim 13, wherein the determining of the composite phase offset value includes calculating a root mean square of maximum phase offset values for each of the plurality of time slots.

18. The method of claim 13, wherein the determining of the composite phase offset value includes determining a percentile ranking of the phase offsets of the plurality of time slots, the composite phase offset value corresponding to a phase offset value associated with a predefined percentile ranking.

19. The method of claim 13, wherein the plurality of subcarriers are associated with a phase offset measurement.

20. The method of claim 13, wherein the plurality of time slots are within a time domain window for bundling demodulation reference signal (DMRS).

21. (canceled)

22. The method of claim 13, further comprising reporting at least one of the wireless device transmission coherence performance and the composite phase offset value.

23. (canceled)

24. (canceled)
